(19) United States
(12) Patent Application Publication
(10) Pub. No.: US 2015/0000535 A1
(43) Pub. Date: Jan. 1, 2015

(54) COOKING DEVICE

(71) Applicant: Sharp Kabushiki Kaisha, Osaka (JP)

(72) Inventors: Akihiro YOSHIDOME, Osaka-shi (JP); Masayuki IWAMOTO, Osaka-shi (JP)

(73) Assignee: Sharp Kabushiki Kaisha, Osaka (JP)

(21) Appl. No.: 14/269,283

(22) Filed: May 5, 2014

(30) Foreign Application Priority Data
Jun. 27, 2013 (JP) 2013-135121

(51) Int. Cl. A47J 27/62; F24C 15/32

(52) U.S. Cl. CPC A47J 27/62; F24C 15/327
USPC 99/331; 126/21 A

(57) ABSTRACT

A cooking apparatus includes a bottomed-box-shaped container that contains an object; a discharging path through which at least part of hot air is discharged to the outside; an exhaust adjustment unit that adjusts the flow rate of discharge of the hot air through the discharging path; and a controlling unit that controls the exhaust adjustment unit, wherein the controlling unit controls the exhaust adjustment unit in such a manner that the flow rate of discharge of the hot air during a heating operation falls within a predetermined condition.

### BACKGROUND

1. Field

The present disclosure relates to a cooking apparatus that heats an object by blowing hot air to the object.

2. Description of the Related Art

In recent years, people's awareness of health has been increasing. One recommended method for maintaining health is to reduce an intake of oil or fat. To address this, apparatuses (U.S. Patent Application Publication No. 2010/0028514 and International Publication No. 2012/032449) that can cook without using cooking oil or using a small amount of cooking oil have been developed.

For example, U.S. Patent Application Publication No. 2010/0028514 and International Publication No. 2012/032449 each describe a food preparing apparatus that cooks a food by blowing hot air having a high temperature to the food inside the apparatus. Such food preparing apparatuses are capable of preparing food with a small amount of cooking oil or without using cooking oil since they cook food by blowing hot air to food or by heating food with radiant heat. Such food preparing apparatuses suppress a reduction in temperature of hot air by circulating the hot air inside the apparatuses.

Although the food preparing apparatuses according to U.S. Patent Application Publication No. 2010/0028514 and International Publication No. 2012/032449 suppress a reduction in temperature of hot air and adjust the temperature of hot air, these apparatuses are not suitable for maintaining hot air at a lower temperature or raising hot air to a high temperature and then lowering the temperature. Thus, these apparatuses are poor at preparation of high-quality dish that requires use of a low temperature or lowering the temperature and maintaining the food at the lowered temperature.

Since many food materials internally contain water, steam arises when such food materials are heated. Since the existing food preparing apparatuses described above circulate hot air, the steam that has arisen as a result of heating a food material circulates together with hot air. When the steam from the food material is mixed with the hot air, the humidity of the circulating hot air increases. When the hot air having a high humidity is blown to the food material, the prepared food material (mainly the surface) may have a poor quality. Some food preparation methods may include removing water from (drying) a food material. If hot air that is blown to the food material has a high humidity, removal of water from the food material may become difficult, so that the prepared food material may have a poor quality.

Moreover, oil or fat evaporates as a result of heating some food materials and the evaporating oil or fat is mixed with hot air, in the same manner as the steam, and circulated inside the food preparing apparatus. When the hot air containing the evaporating oil or fat is blown to the food material, the oil or fat adheres to the food material again, whereby an oil/fat reduction effect may be weakened.

### SUMMARY

Accordingly, a cooking apparatus is provided that performs food preparation by blowing hot air to an object, that can perform food preparation at an appropriate temperature with minimum energy consumption, and that can hinder steam, evaporated oil or fat, or the like from degrading the quality of the prepared object.

According to an aspect of the present disclosure, a cooking apparatus performs a heating operation by blowing hot air to an object, the apparatus including a circulation path through which the hot air is circulated, a bottomed-box-shaped container that contains the object, a discharging path through which at least part of the hot air is discharged to the outside, an exhaust adjustment unit that adjusts the flow rate of discharge of the hot air through the discharging path, and a controlling unit that controls the exhaust adjustment unit, wherein the exhaust adjustment unit is disposed at a portion of the discharging path, and the controlling unit controls the exhaust adjustment unit in such a manner that the flow rate of discharge of the hot air during the heating operation falls within a predetermined condition.

### BRIEF DESCRIPTION OF THE DRAWINGS

FIG. 1 is a front view of a cooking apparatus according to an embodiment of the present disclosure.

FIG. 2 is a cross-sectional view of the cooking apparatus illustrated in FIG. 1, viewed from the side.

FIG. 3 is a cross-sectional view of an inner pan, viewed from the side.

FIG. 4 is a block diagram of the cooking apparatus illustrated in FIG. 1.

FIG. 5 is a timing chart illustrating an example of an operation of the cooking apparatus illustrated in FIG. 1.

FIG. 6 is a timing chart illustrating another example of an operation of the cooking apparatus illustrated in FIG. 1.

FIG. 7 is a block diagram of a cooking apparatus according to another example of the present disclosure.

FIG. 8 is a timing chart illustrating an example of an operation of the cooking apparatus illustrated in FIG. 7.

FIG. 9 illustrates an example of a front board included in a cooking apparatus according to some embodiments of the present disclosure.

FIG. 10 illustrates another example of a front board included in a cooking apparatus according to some embodiments of the present disclosure.

FIG. 11 illustrates another example of a front board included in a cooking apparatus according to some embodiments of the present disclosure.

### DESCRIPTION OF THE EMBODIMENTS

Referring now to the drawings, embodiments of the present disclosure are described below.

### First Embodiment

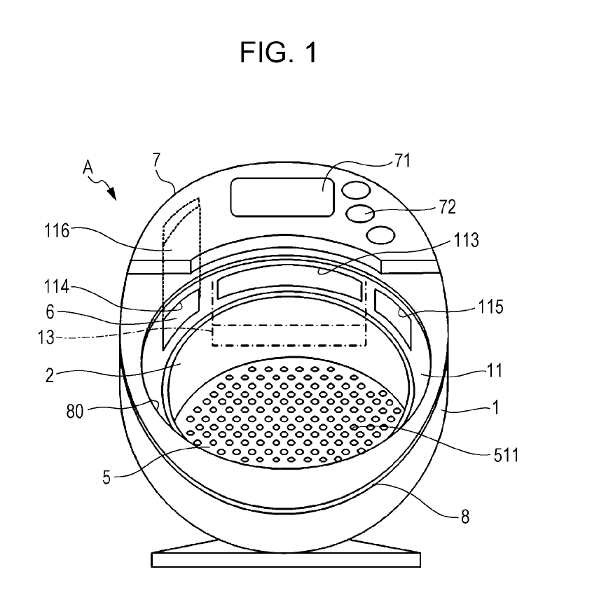

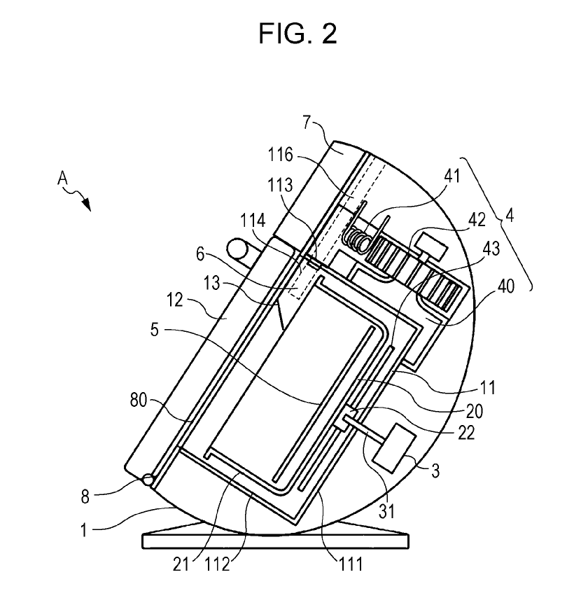

FIG. 1 is a front view of a cooking apparatus A according to a first embodiment of the present disclosure and FIG. 2 is a cross-sectional view of the cooking apparatus A illustrated in FIG. 1, viewed from the side. FIG. 1 does not illustrate a door from the cooking apparatus A for convenience sake.

The cooking apparatus A is an apparatus that performs a heating operation by blowing hot air to an object disposed inside of it. As illustrated in FIGS. 1 and 2, the cooking apparatus A includes a housing 1, an inner pan 2 (container), a motor (driving unit) 3 that drives the inner pan 2 to rotate, a heating unit 4 that generates hot air, an object receiving member 5 disposed in the inner pan 2 and on which an object is placed, an exhaust damper 6 (exhaust adjustment unit) that adjusts the flow rate of discharge of hot air, an operating unit 7, and a front board 8 disposed on the front side of the housing 1. The inner pan 2, the motor 3, and the heating unit 4 are disposed inside the housing 1. In the cooking apparatus A, the inner pan 2 is rotated in the state where the rotation axis is inclined with respect to the vertical line. However, this is not the only possible structure. The rotation axis may be parallel to the vertical line, that is, the rotation axis may be perpendicular to the horizontal surface.

The housing 1 is a member serving as an outer covering of the cooking apparatus A and has an opening in the front surface. A front board 8 is attached to the opening in the front surface. The front board 8 is attached to the opening of the housing 1 to reinforce the housing 1. The front board 8 has an open window 80, which is a circular hole, as will be described below.

A bottomed cylindrical outer pot 11 is disposed inside the housing 1. The outer pot 11 includes a disk-shaped bottom surface 111 and a side peripheral portion 112 that rises from the edge of the bottom surface 111 and has a cylindrical shape. An end portion of the side peripheral portion 112 opposite to the end portion adjacent to the bottom surface 111 is in close contact with the front board 8. As illustrated in FIGS. 1 and 2, the side peripheral portion 112 is in close contact with a portion adjacent to the edge of the open window 80. As illustrated in FIG. 2, in the cooking apparatus A, the open window 80 and the side peripheral portion 112 have the same inner diameter. However, this is not the only possible structure. The inner diameter of the side peripheral portion 112 may be larger than the inner diameter of the open window 80 so that the end portion of the side peripheral portion 112 is coupled to the front board 8 without leakage of hot air.

The housing 1 also includes a door 12 installed so as to be openable and closeable with respect to the opening of the outer pot 11. As illustrated in FIG. 2, the door 12 is a door that is rotated around a hinge (rotated downward in FIG. 2). The door 12 has such a structure as to be capable of being in close contact with the front board 8 (for example, a structure including packing) in order to minimize leakage of air inside the housing 1 (outer pot 11).

An inner pan 2 is rotatably disposed inside the outer pot 11. The inner pan 2 has a bottomed cylindrical shape. The inner pan 2 includes a bottom portion 20, a cylindrical peripheral wall 21 coupled with the bottom portion 20 so that the peripheral wall 21 and the bottom portion 20 are integrated into a unit, and a connection portion 22 that protrudes from a center portion of the bottom portion 20 on the external side, that is, protrudes in a direction opposite to the direction in which the peripheral wall 21 extends, an output shaft 31 of the motor 3 being fixed to the connection portion 22. The output shaft 31 is described below. As described above, the inner pan 2 is disposed inside the outer pot 11. Specifically, the inner pan 2 is rotatably disposed inside the outer pot 11. Thus, the bottom portion 20 of the inner pan 2 is smaller than the bottom portion 111 of the outer pot 11 and the cylindrical peripheral wall 21 of the inner pan 2 has a smaller diameter than the side peripheral portion 112 of the outer pot 11. The inner pan 2 may be removable from the outer pot 11 or the inner pan 2 may be omitted in the case where an object can be cooked by using only the outer pot 11.

An air outlet 113, an exhaust port 114, and an intake port 115, which are holes (openings), are also formed in a portion of the side peripheral portion 112 of the outer pot 11 that does not overlap with the inner pan 2. In the cooking apparatus A, the outer pot 11 is in close contact with the front board 8 and the door 12 is in close contact with the front board 8. Thus, when the door 12 is closed in the cooking apparatus A, only the air outlet 113, the exhaust port 114, and the intake port 115 allow hot air to pass therethrough in the space defined by the outer pot 11 and the door 12.

A heating unit 4 is disposed on the external side of the outer pot 11. The heating unit 4 includes a circulation flow path 40 through which hot air is circulated. The heating unit 4 also includes a heater 41 and a fan 42 inside the circulation flow path 40. The fan 42 generates an airflow (hot air). In the heating unit 4, the heater 41 heats the airflow generated by the fan 42 to generate hot air. The heating unit 4 also includes a heating device 43 between the outer pot 11 and the inner pan 2. In the case where the temperature of hot air flowing in the inner pan 2 is negligibly lowered, the heating device 43 may be omitted.

An end portion of the circulation flow path 40 on an exhaust side of the fan 42 is formed into the air outlet 113 and an end portion of the circulation flow path 40 on an intake side of the fan 42 is formed into the intake port 115. In this structure, when the fan 42 is driven, hot air flowing through the circulation flow path 40 is blown out from the air outlet 113 and then flows from the intake port 115 to the circulation flow path 40. In addition, the circulation flow path 40 may have an air vent (not illustrated) to exhaust the circulating hot air to the outside when the internal pressure of the space defined by the outer pot 11 and the door 12 is high or to let air in from the outside when the internal pressure is low. The air vent may be so sized that the internal pressure of the space defined by the outer pot 11 and the door 12 can be adjusted.

In the cooking apparatus A, hot air, which is air blown by the fan 42 and then heated by the heater 41, passes through the circulation flow path 40 and then flows into the inner pan 2 from the air outlet 113. An object (food) disposed inside the inner pan 2 is heated by receiving hot air. The hot air in the inner pan 2 flows from the intake port 115 through the circulation flow path 40 back to the fan 42. Specifically, in the cooking apparatus A, hot air is circulated between the inner pan 2 and the circulation flow path 40.

Now, the exhaust port 114 is described. The exhaust port 114 is an opening through which part of hot air that has flowed into the outer pot 11 is exhausted to the outside. An exhaust duct 116, which communicates with the outside the cooking apparatus A (housing 1), is connected to the exhaust port 114. The exhaust port 114 and the exhaust duct 116 constitute a discharging path. An exhaust damper 6 that opens and closes the exhaust port 114, that is, that adjusts the flow rate of hot air flowing through the exhaust port 114 is disposed at the exhaust port 114. The exhaust damper 6 is controlled in accordance with an instruction from a controller 91, described below, so as to open and close the exhaust port 114.

Examples of the exhaust damper 6 include a damper that opens or closes the exhaust port 114 by rotating a plate-shaped opening/closing plate provided so as to be rotatable using a hinge. However, this is not the only possible structure. Various other devices that can open and close the exhaust port 114 in accordance with an instruction from the controller 91 can be used.

In the cooking apparatus A, the exhaust damper 6 closes the exhaust port 114 when the exhaust damper 6 is not supplied with power and the exhaust damper 6 opens the exhaust port 114 in response to an instruction from the controller 91, that is, the exhaust damper 6 has a normally closed structure.

When the exhaust damper 6 is in the closed state, the exhaust port 114 is closed. Thus, in the outer pot 11, the air outlet 113 and the intake port 115 serve as openings that communicate with the external side of the outer pot 11. Here, the air outlet 113 is an opening that allows hot air to flow into the outer pot 11 from the external side of the outer pot 11 and thus hot air in the outer pot 11 flows from the intake port 115 into the circulation flow path 40. In this manner, when the exhaust damper 6 (exhaust port 114) is closed, hot air blown from the air outlet 113 to the inner pan 2 circulates between the outer pot 11 and the circulation flow path 40.

When the exhaust damper 6 is in the open state, the exhaust port 114 is opened. At this time, in the outer pot 11, the exhaust port 114 and the intake port 115 serve as openings through which hot air inside is exhausted to the external side of the outer pot 11. Thus, part of hot air in the outer pot 11 passes through the exhaust port 114 and the exhaust duct 116 and is exhausted to the outside the cooking apparatus A. Remaining part of hot air flows into (circulates) the circulation flow path 40 through the intake port 115 as described above. In this manner, whether hot air is circulated inside the cooking apparatus A or partially exhausted to the outside can be selected by operating the exhaust damper 6.

In the case of a structure that can capture external air by opening the exhaust damper 6 through the exhaust duct 116, an air vent of the circulation flow path 40 may be omitted. In the case where external air flows into the cooking apparatus A through the exhaust duct 116 and (or) the air vent, a filter that blocks entry of impurities such as dust may be provided.

As illustrated in FIGS. 1 and 2, the air outlet 113 is formed at a portion of the side peripheral portion 112 of the outer pot 11 and evenly blowing hot air to a food inside the inner pan 2 is difficult by only blowing the hot air from the air outlet 113. In view of this, a flow adjusting member (air-direction adjusting portion) 13 that changes the direction of hot air blown from the air outlet 113 toward the internal side of the inner pan 2 is disposed in the housing 1 on the internal side of the outer pot 11. The flow adjusting member 13 is attached to the door 12.

In the cooking apparatus A, the motor 3 is disposed on the external side of the bottom portion 111 of the outer pot 11. A hole through which the output shaft 31 of the motor 3 penetrates is formed in a center portion of the bottom portion 111 of the outer pot 11. Although not illustrated, a bearing that rotatably supports the output shaft 31 may be disposed at the hole. The connection portion 22 provided at the bottom portion 20 of the inner pan 2 is connected to the end of the output shaft 31.

The motor 3 is fixed to the housing 1. When the motor 3 rotates, the inner pan 2 connected to the output shaft 31 also rotates. When the inner pan 2 rotates, hot air blown from the air outlet 113 can be evenly or substantially evenly blown to the object placed inside, whereby the variance in cooking (heating) can be minimized. The end of the output shaft 31 and the connection portion 22 are engaged with each other in such a manner that they are slidable in the axial direction of the output shaft 31 but not disconnected from each other in the circumferential direction (for example, a device having a polygonal cross section or a device that fits a groove and a ridge together). The inner pan 2 may have a structure that does not rotate. In this case, the driving unit including the motor 3 may be omitted.

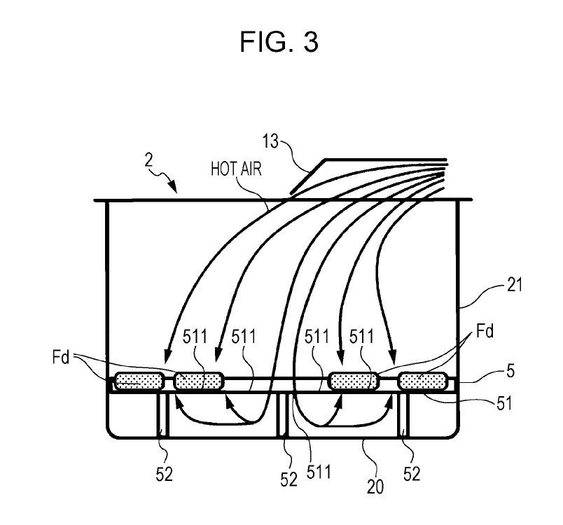

When the cooking apparatus A heats an object (food), hot air may be blown to the object from upper and lower surfaces of the object. In the cooking apparatus A, an object receiving member 5 on which a food Fd, which is an object, is placed is attached to an inside of the inner pan 2. FIG. 3 is a cross-sectional view of the inner pan included in the cooking apparatus illustrated in FIG. 1. The object receiving member 5 is a component removably disposed inside the inner pan 2. The object receiving member 5 includes a flat tray 51, on which a food Fd is placed, and leg portions 52 that protrude from the back surface of the tray 51, which is opposite to the receiving surface on which a food Fd is placed. In the object receiving member 5, the leg portions 52 come into contact with a bottom portion 20 of the inner pan 2 and the tray 51 is thus aligned with the bottom portion 20 (for example, arranged parallel to the bottom portion 20).

The tray 51 is a component disposed inside the inner pan 2 and has a circular shape when viewed in a plan. The circumferential portion of the tray 51 is folded to increase the strength. The tray 51 has a large number of holes (ventilation portions) 511 through which hot air passes. The holes 511 of the tray 51 are evenly or unevenly formed over the tray 51. The tray 51 is disposed on the inner pan 2 using a component that is not rotated with respect to the inner pan 2, that is, prevented from being rotated relative to the inner pan 2.

In the cooking apparatus A, hot air flowing in a direction adjusted by the flow adjusting member 13 is blown from the opening of the inner pan 2 to the receiving surface of the tray 51 inside. Since the tray 51 has the holes 511, hot air blown to the receiving surface can pass through the holes 511. Hot air then passes through the holes 511 of the tray 51 and can be blown to the placed food Fd through the tray 51. In this manner, hot air is blown to the food Fd, placed on the tray 51 of the object receiving member 5, from both sides of the food Fd. Thus, the food Fd can be evenly or substantially evenly heated.

Four leg portions 52 are provided on the back surface of the tray 51. Hot air that has passed through the holes 511 flows in the space between the back surface of the tray 51 and the bottom portion 20 of the inner pan 2. Thus, the leg portions 52 have a prism shape of such a size that the flow of hot air is not blocked. In the object receiving member 5, the leg portions 52 are cylindrical. Since the leg portions 52 are in contact with the bottom portion 20 of the inner pan 2, the length of the leg portions 52 is the distance between the bottom portion 20 and the tray 51 when the object receiving member 5 is disposed inside the inner pan 2.

When the cooking apparatus A cooks a food Fd, the food Fd is placed on an upper surface of the tray 51 while the object receiving member 5 is disposed inside the inner pan 2. Then, the heating unit 4 generates hot air and blows the hot air into the inner pan 2 from the air outlet 113. The hot air blown toward the tray 51 is blown to the upper surface of the food Fd placed on the upper surface of the tray 51, so that the food Fd is heated.

The upper surface of the tray 51 has a portion on which the food Fd is not placed and the holes 511 in that portion are not covered by the food Fd. Thus, part of the hot air blown to the portion on which the food Fd is not placed passes through the holes 511 and flows in the space between the back surface of the tray 51 and the bottom portion 20 of the inner pan 2. As described above, the holes 511 are entirely formed over the tray 51 at uniform intervals. Thus, the hot air that has flowed into the space between the back surface of the tray 51 and the bottom portion 20 of the inner pan 2 passes through the holes 511 and is blown to the food Fd from the side facing (touching) the tray 51.

As described above, in the cooking apparatus A in which hot air is blown from the opening of the inner pan 2 after the food Fd is placed on the object receiving member 5, hot air can be evenly or substantially evenly blown to the food Fd without the need of stirring or turning the food Fd. Thus, the food Fd can be evenly or substantially evenly heated without being mixed or broken.

In the cooking apparatus A, a band-shaped object-free region may be provided at a center portion of the tray 51. This is not the only possible object-free region. Alternatively, a circular object-free region may be provided at the center portion of the tray 51 or an annular object-free region may be provided at the outer peripheral portion. The shape or the size of the object-free region is not particularly limited. Specifically, the object-free region can be formed in various shapes or sizes as long as hot air can be evenly or substantially evenly blown to the food Fd, placed on the upper surface of the tray 51, from above or below the food Fd when the hot air is blown into the inner pan 2 while the inner pan 2 is rotated.

In the above-described cooking apparatus A, the object receiving member 5 is disposed in the inner pan 2. This is not the only possible structure. In the case of heating a tough, hardly breakable food such as a potato or beans, the object receiving member 5 is not necessarily provided. Specifically, in the case of heating a tough, hardly breakable food, the food may be directly placed in the inner pan 2 and the food may be directly moved by rotating the inner pan 2. By directly moving the food, the food can be evenly heated by receiving hot air.

Alternatively, a stirring member that rotates with respect to the inner pan 2 may be provided in the inner pan 2 to stir the food. At this time, the inner pan 2 may be stopped while the stirring member is rotated or the inner pan 2 may be rotated while the stirring member is stopped. Instead, both the inner pan 2 and the stirring member may be rotated. In this case, the inner pan 2 and the stirring member may be rotated in opposite directions or rotated at different rates. In this manner, since the food is stirred with the stirring member, the food can be evenly heated by receiving hot air.

An operating unit 7 is disposed at an upper portion of the cooking apparatus A. As described above, the operating unit 7 is fixed to the front board 8. The operating unit 7 includes a display portion 71, which displays various information such as the current state of the cooking apparatus A, time, or an operation menu, and an input portion 72, to which an operator inputs information.

The front board 8 has an elliptic shape that overlaps the opening in the front surface of the housing 1. The front board 8 is a plate made of a metal (for example, a stainless steel or aluminum) and serves as a reinforcement member that increases the strength of a portion of the housing 1 around the opening by being attached to the front surface of the housing 1. In other words, the housing 1 and the front board 8 constitute a chassis of the cooking apparatus A. The front board 8 includes an open window 80 that allows access to the inner pan 2.

The side peripheral portion 112 of the outer pot 11 is brought into close contact with the front board 8 so that a gap is prevented from being formed between the side peripheral portion 112 of the outer pot 11 and the front board 8, whereby leakage of hot air is minimized. In the case where the edge portion of the open window 80 is formed so as to be continuous with the side peripheral portion 112 of the outer pot 11, a food material, water, or the like dropped inside the outer pot 11 can be removed by only tilting the cooking apparatus A toward the front side. Thus, the open window 80 and the side peripheral portion 112 may be formed so as to have the same inner diameter. In the case where the front board 8 is made of a plastically deformable plate, the front board 8 and the outer pot 11 can be formed in one unit (by, for example, deep drawing).

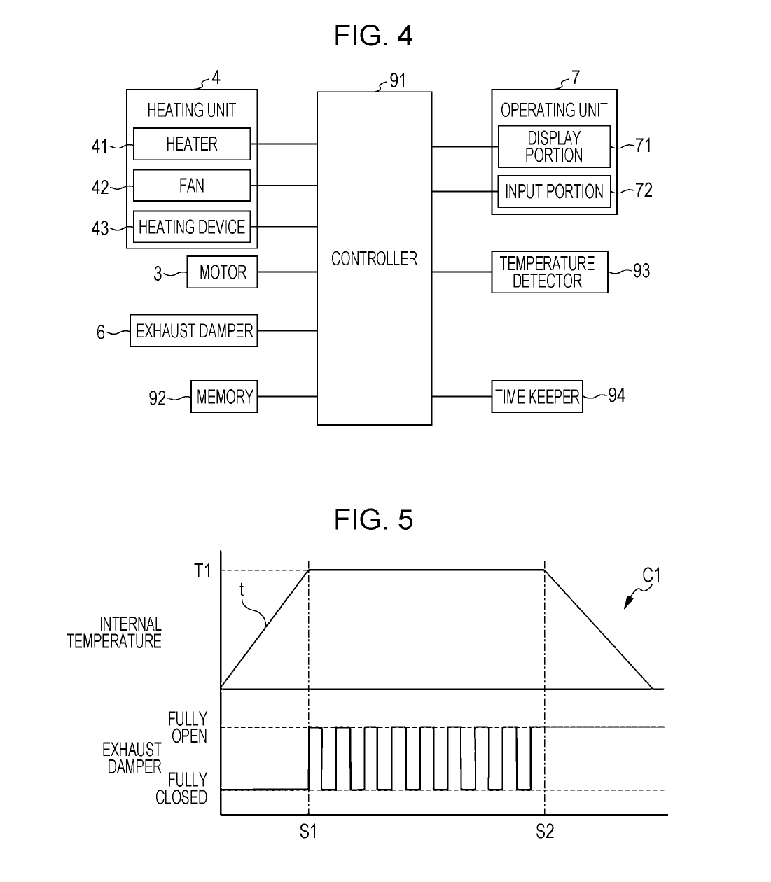

The above-described cooking apparatus A has the configuration illustrated in FIG. 4. FIG. 4 is a block diagram of a cooking apparatus A according to an embodiment of the present disclosure. As illustrated in FIG. 4, in addition to the motor 3, the heating unit 4, the exhaust damper 6, and the operating unit 7, the cooking apparatus A includes a controller 91 (controlling unit), a memory 92 (recording unit), a temperature detector 93 (temperature detecting unit), and a time keeper 94. The controller 91 is a processing device that performs various processing and includes a processor such as a microprocessing unit (MPU).

The temperature detector 93 includes a temperature sensor that detects the internal temperature of the inner pan 2. The temperature detector 93 detects the internal temperature of the inner pan 2 and transmits the temperature information to the controller 91. Examples of the temperature sensor used as the temperature detector 93 include a contact-type thermometer that directly detects the internal temperature and a radiation thermometer that detects the internal temperature without a contact. Alternatively, as needed, the temperature detector 93 may detect the external temperature of the cooking apparatus A.

The time keeper 94 holds the current time, measures time that has elapsed from the start of cooking, time that has elapsed from a time point at which a certain condition is satisfied, or other time required by the controller 91, and transmits the time information to the controller 91. In the following description, the controller 91 manages time in some cases. In such cases, even though not particularly described, it is assumed that the time keeper 94 passes time information to the controller 91.

As described above, the display portion 71 of the operating unit 7 is a display device that displays the current state of the cooking apparatus A (for example, the temperature, the humidity, or other conditions), time (time elapsed from the start of cooking, the current time, or the like), or operations (for example, the current operation or other operations). The display portion 71 performs display under control of the controller 91. The display portion 71 may be, for example, a display device that can display an image, characters, or others, such as a liquid crystal panel, or may display the state using a luminous body such as a LED.

The input portion 72 is an input interface to which a person who cooks (a cook, below) inputs a desired operation. The information of the operation input through the input portion 72 is transmitted to the controller 91. As illustrated in FIG. 1, the input portion 72 includes three push buttons. However, this is not the only possible structure. The input portion 72 may have other input interface such as a numeric keypad having numerals of 0 to 9 or a directional keypad. Alternatively, the input portion 72 may be displayed on a so-called touch panel as an image and may detect an input when a finger of a cook or a special contact member (for example, a touch pen) touches the input portion 72.

The controller 91 controls the operations of the motor 3, the heating unit 4, and the exhaust damper 6. The cooking apparatus A includes a memory 92 accessible by the controller 91. The memory 92 includes database (not illustrated) in which cooking conditions (such as the temperature, time, and whether or not the inner pan is rotated) for each dish are stored. The memory 92 may be a read-only memory (ROM), a random access memory (RAM), or a removable memory such as a memory card. A device that can record information is widely referred to as a memory here.

When the cooking apparatus A performs cooking, the temperature or time required for cooking each object or each dish has been predetermined in most of the cases. It is thus important for the cooking apparatus A to manage the temperature of hot air and the internal temperature of the inner pan 2. In this disclosure, the temperature detector 93 detects the internal temperature of the inner pan 2 and the controller 91 acquires information of the internal temperature from the temperature detector 91. The controller 91 controls the heating unit 4 and the exhaust damper 6 on the basis of the internal temperature. Actually, the controller 91 also controls the motor 3 to control the rotation of the inner pan 2. This rotation of the inner pan 2 is made for evenly or substantially evenly blowing hot air to the object disposed inside the inner pan 2 and is not directly related to an increase in temperature of the inner pan 2. Thus, the control of the motor 3 performed by the controller 91 is not described in the following description.

Now, an adjustment of the temperature of the inner pan 2 performed by the cooking apparatus A will be described below. In this embodiment, the heater 41 and the fan 42 are assumed to be operated at a uniform output. As illustrated in FIG. 5, the exhaust damper 6 is operated so as to be in a fully open state or fully closed state.

Firstly, the relationship between the exhaust damper 6 and the internal temperature t will be described. When the exhaust damper 6 is in the closed state, air negligibly leaks to the outside from the space defined by the outer pot 11 and the door 12. Hot air in the space defined by the outer pot 11 and the door 12 flows into the circulation flow path 40 from the intake port 115. Specifically, the hot air circulates between the space defined by the outer pot 11 and the door 12 and the heating unit 4 (inside the cooking apparatus A). The hot air that passes through the circulation flow path 40 is heated by the heater 42 and the temperature of the circulating hot air thus increases, whereby the internal temperature t in the space defined by the outer pot 11 and the door 12 (inner pan 2) increases. In the cooking apparatus A, the inner pan 2 is disposed in the space defined by the outer pot 11 and the door 12. Thus, the inner pan 2 may also refer to the space defined by the outer pot 11 and the door 12.

When the exhaust damper 6 is switched to the open state, part of hot air circulating between the space defined by the outer pot 11 and the door 12 and the heating unit 4 flows out of the cooking apparatus A through the exhaust port 114 and the exhaust duct 116. In place of the hot air that has flowed out, external air flows in from the outside the cooking apparatus A through the exhaust duct 116 and (or) the air vent. Here, since the temperature of air that flows in from the outside is lower than the hot air that flows out of the cooking apparatus A, the temperature of hot air inside the cooking apparatus A decreases. In this manner, the temperature of hot air is reduced by switching the exhaust damper 6 to the open state and the internal temperature t of the inner pan 2 can thus be reduced or maintained at a uniform temperature.

The degree of reduction in temperature of the hot air is determined by the temperature of air outside the cooking apparatus A and the flow rate of intake of air. In the cooking apparatus A, the ratio of the open state and the closed state of the exhaust damper 6 is adjusted to adjust the flow rate of discharge of hot air, that is, the flow rate of intake of external air, whereby the temperature of hot air and the internal temperature t of the inner pan 2 are adjusted. The controller 91 controls the ratio of the open state of the exhaust damper 6 (the length of time for which the exhaust damper 6 is in the open state per unit time) in such a manner that the internal temperature t acquired from the temperature detector 93 becomes a determined temperature.

Now, dishes cooked by the cooking apparatus A will be described. As described above, the memory 92 of the cooking apparatus A includes database of the dishes. In the database, cooking conditions for each dish such as the cooking temperature or the length of time for which the temperature is kept are stored. For example, the cooking conditions for a first dish C1 (for example, a fried pork cutlet), which is one example of the dishes, are “to increase the internal temperature t of the inner pan 2 to a first temperature T1 as soon as possible after the start of the operation”, “to keep the internal temperature t of the inner pan 2 at the first temperature T1 for a predetermined length of time”, and “to reduce the temperature of the inner pan 2 as soon as possible”.

The operation of the cooking apparatus A when cooking the first dish C1 is described now. FIG. 5 is a timing chart illustrating the internal temperature of the inner pan and the operation state of the exhaust damper. Here, the internal temperature indicates an example of the state of the cooking operation of the cooking apparatus according to the embodiment. In the timing chart illustrated in FIG. 5, the upper part indicates the internal temperature t of the inner pan 2, whereas the lower part indicates the operation of the exhaust damper 6.

Firstly, a cook performs a desired operation using the input portion 71 (here, selects the first dish C1). When the input portion 71 receives an input operation, the input portion 71 transmits information of the input (here, the determination of the first dish C1) to the controller 91. The controller 91 calls the cooking conditions for the first dish C1 from the database of the memory 92.

When the input portion 71 receives an input of the start of cooking, information on the cooking start is transmitted to the controller 91 and the controller 91 drives the heater 41 and the fan 42 to start blowing hot air from the air outlet 113. Concurrently with the start of cooking, the temperature detector 93 detects the internal temperature t of the inner pan 2 and passes information of every detection (periodically) to the controller 91. The controller 91 adjusts the ratio of the open state of the exhaust damper 6 on the basis of the information of the internal temperature t to control the exhaust damper 6 through the open-state ratio.

As illustrated in FIG. 5, in the cooking apparatus A, the internal temperature t of the inner pan 2 is lower that the first temperature T1 immediately after the start of cooking. Since one of the cooking conditions for the first dish C1 is “to increase the internal temperature t of the inner pan 2 to the first temperature T1 as soon as possible”, the controller 91 controls the exhaust damper 6 so that the exhaust damper 6 is in the closed state until the internal temperature t of the inner pan 2 reaches the first temperature T1. Thus, hot air is heated by the heater 41 while circulating inside the cooking apparatus A, whereby the temperature rapidly increases. In FIG. 5, the temperature reaches the first temperature T1 at the time S1 after the start.

Another one of the cooking conditions for the first dish C1 is “to keep the internal temperature t of the inner pan 2 at the first temperature T1 for a predetermined length of time (here, from the cooking start to the time S2)”. If the hot air keeps circulating inside the cooking apparatus A, the temperature of the hot air increases further and the internal temperature t of the inner pan 2 consequently increases beyond the first temperature T1. Thus, the controller 91 controls the exhaust damper 6 so that the exhaust damper 6 is in the open state to exhaust part of the hot air from the exhaust port 114, so that the temperature of the hot air is regulated.

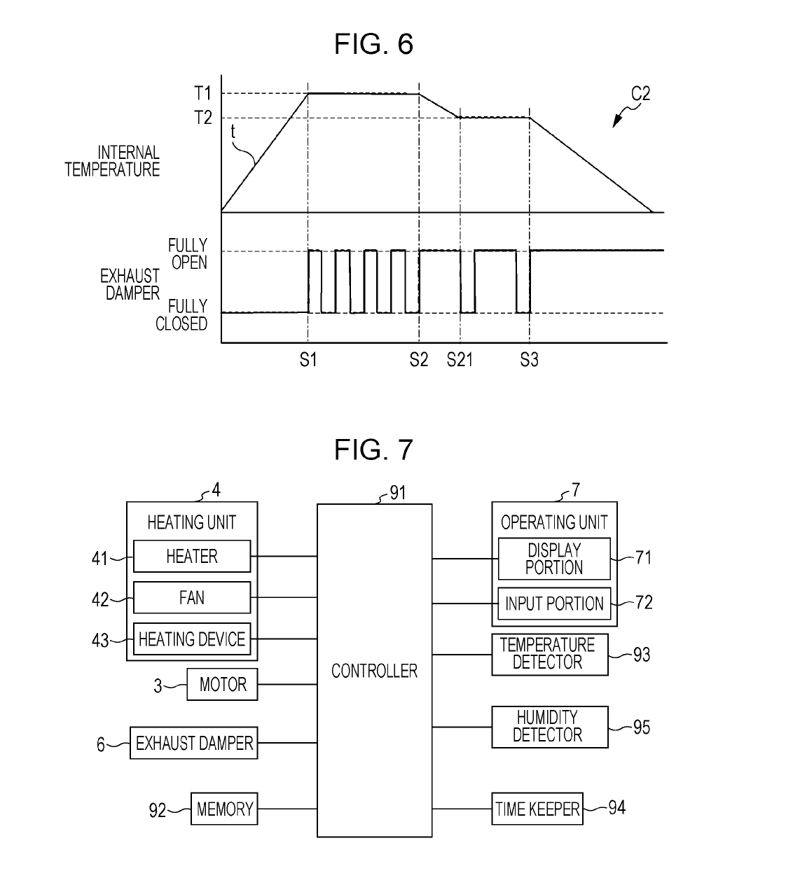

The temperature of hot air inside the cooking apparatus A is increased or reduced by switching the exhaust damper 6 between the closed state and the open state. Although the hot air is blown to the inside of the inner pan 2, the temperature of the inner pan 2 is negligibly affected by an increase or reduction of the temperature of hot air and is kept at a substantially uniform temperature. Thus, as illustrated in FIG. 6, the internal temperature t of the inner pan 2 is assumed to be kept at the first temperature T1.

The control performed by the controller 91 is described in detail now. The controller 91 acquires information of the internal temperature t of the inner pan 2 from the temperature detector 93. The controller 91 controls the opening and closing states of the exhaust damper 6 by setting the open-state ratio to a predetermined value. The controller 91 thus adjusts (finely adjusts) the ratio of the open state of the exhaust damper 6 on the basis of information of the internal temperature t from the temperature detector 93. In FIG. 5, the controller 91 controls the opening and closing states of the exhaust damper 6 so that the ratio of the open state of the exhaust damper 6 becomes 0.5 (that is, so that the exhaust damper 6 is in the open state and in the closed state for the same length of time).

Information of the external temperature, the set internal temperature t (here, the first temperature T1), and the ratio of the open state of the exhaust damper 6 may be stored in the memory 92 as a database and the exhaust damper 6 may be controlled at the open-state ratio that meets the conditions from the database. Here, the controller 91 may finely adjust the open-state ratio. Moreover, the temperature detector 93 may detect the external temperature outside the cooking apparatus A. Alternatively, another detecting portion that separately detects the external temperature may be provided and the detecting portion may transmit the information of the temperature to the controller 91. Here, the temperature detector 93 is assumed to detect the internal temperature.

Another one of the cooking conditions for the first dish C1 is “to reduce the internal temperature t of the inner pan 2 as soon as possible”. Thus, the controller 91 then controls the exhaust damper 6 in such a manner that the hot air inside the cooking apparatus A having a high temperature is exhausted to the outside as soon as possible. The controller 91 controls the exhaust damper 6 so that the exhaust damper 6 is kept at the open state for effective exhaustion of hot air to the outside (see FIG. 5). Here, since the hot air is no longer required to be blown to the object, the heater 41 is stopped. On the other hand, the fan 42 is kept rotating to facilitate exhaustion of hot air from the exhaust port 114.

The adjustment described above enables an adjustment of the temperature of hot air with a simple method such as by switching the exhaust damper 6 between the open state and the closed state. Moreover, since the temperature of hot air is adjusted by exhausting the hot air, that is, letting air in from the outside, the temperature of the hot air can be adjusted in a shorter time than in the case of an adjustment of an output of the heater 42. Since the cooking apparatus A according to the embodiment has such characteristics, the temperature of hot air can be accurately adjusted and the internal temperature t of the inner pan 2 can thus be accurately adjusted. Consequently, the cooked object can have a fine quality.

A different dish may be selected by a cook. For example, the cooking conditions for a second dish C2 (for example, a Hamburg steak) are “to keep the internal temperature t of the inner pan 2 at the first temperature T1 for a predetermined length of time”, “to keep the internal temperature t at a second temperature T2, which is lower than the first temperature T1, for a predetermined time period”, and then to cool down. The operation of the cooking apparatus A when cooking the second dish will be described referring to the drawings. FIG. 6 is a timing chart illustrating the internal temperature of the cooking apparatus used for cooking a different dish and the operation of the exhaust damper.

On the basis of the cooking conditions for the second dish C2, the controller 91 controls the exhaust damper 6 in the same manner, up to the time S2, as in the case of cooking the first dish C1 illustrated in FIG. 5. Thus, the control is not described in detail here. When the internal temperature t of the inner pan 2 is changed from the first temperature T1 to the second temperature T2, a larger amount of hot air may be exhausted to the outside. To this end, the controller 91 keeps the exhaust damper 6 to the fully open state after the time S2 until the internal temperature t of the inner pan 2 becomes the second temperature T2 (at the time S21). In order to keep the internal temperature t of the inner pan 2 at the second temperature T2, the temperature of hot air is required to be kept low.

Thus, the controller 91 controls the exhaust damper 6 so as to increase the open-state ratio. In the example illustrated in FIG. 6, the controller 91 controls the opening and closing states of the exhaust damper 6 so that the ratio of the open state of the exhaust damper 6 becomes 0.75 (that is, the length of time of the open state is three times as large as the length of time of the closed state). As in the case of cooking the above-described first dish C1, the open-state ratio is adjusted so that the internal temperature t of the inner pan 2 becomes the second temperature T2 while the exhaust damper 6 is controlled so as to have a predetermined open-state ratio. This ratio setting is not the only possible way.

The controller 91 then controls the exhaust damper 6 so as to keep the ratio of the open state of the exhaust damper 6 for a predetermined time period from when the internal temperature t of the inner pan 2 becomes the second temperature T2 (from the time S21 to the time S3 after the cooking start). Thereafter, the controller 91 controls the exhaust damper 6 so that the exhaust damper 6 is in the open state and stops the heater 41.

As described above, the control of the opening state and the closing state of the exhaust damper 6 enables an appropriate adjustment of the internal temperature t of the inner pan 2. In the cooking apparatus A, when the internal temperature t of the inner pan 2 is to be changed, the exhaust damper 6 is kept in the closed state when the temperature increase is involved, while the exhaust damper 6 is kept in the open state when the temperature reduction is involved. However, this is not the only possible way. For example, when the internal temperature t of the inner pan 2 is reduced from the first temperature T1 to the second temperature T2, the temperature t may be reduced by switching the exhaust damper 6 between the open state and the closed state at the open-state ratio determined for keeping the second temperature T2. In this case, as illustrated in FIG. 6, the reduction of the internal temperature t of the inner pan 2 slows down. Slowing down the change in temperature with such a control is effective for a dish that can be adversely affected by a rapid reduction of the temperature.

As described above, providing the exhaust port to the cooking apparatus that cooks an object by blowing hot air and providing an exhaust damper for opening or closing the exhaust port facilitate the control of the temperature of hot air flowing inside and enables an accurate adjustment of a heating temperature and cooking time of the object. Thus, the object can be properly heated.

In the above-described cooking apparatus A, the controller 91 controls the opening and closing states of the exhaust damper 6 on the basis of the internal temperature t of the inner pan 2. However, this is not the only possible control method. For example, the controller 91 may set the ratio of the open state of the exhaust damper 6 and the length of time for which the open-state ratio is kept. Alternatively, the controller 91 may calculate the ratio of the open state of the exhaust damper 6 on the basis of both the internal temperature t of the inner pan 2 and the external temperature.

### Second Embodiment

Referring to the drawings, a cooking apparatus according to a second embodiment of the present disclosure will be described. FIG. 7 is a block diagram of a cooking apparatus B according to another embodiment of the present disclosure. The cooking apparatus B illustrated in FIG. 7 includes a humidity detector 95 (humidity detecting unit) and other components are the same as those in the cooking apparatus A. Substantially the same components are denoted by the same reference symbols and are not described in detail.

The humidity detector 95 includes a humidity sensor that detects the internal humidity of the inner pan 2. The humidity detector 95 detects the humidity of hot air and transmits information of the humidity to the controller 91. Since the hot air inside the inner pan 2 is substantially identical with the hot air that circulates through the circulation flow path 40, the humidity of hot air that circulates through the circulation flow path 40 may be detected. At this time, the humidity detector 95 may be disposed on the intake side of the fan 42 at which the flow rate is low.

Dishes such as a fried pork cutlet or a Hamburg steak illustrated in the cooking apparatus A are cooked by blowing hot air having a high temperature to an object for a short period of time. The cooking apparatus B can cook dishes that can be cooked in a short period of time and also process dry foods such as dried fish or dry fruits by blowing dry hot air (having a predetermined humidity or lower) to an object for a long period of time.

When an object is heated by blowing hot air to the object, the water inside the object evaporates. In the cooking apparatus B, the evaporated water circulates together with the hot air. Thus, the humidity of the hot air (relative humidity) increases. When the humidity of the hot air increases, humid hot air is blown to the object, whereby drying the object becomes difficult. Consequently, the dry food processed within predetermined time may have a low quality. In view of this situation, it is important for the cooking apparatus B to adjust the humidity of hot air, in addition to the temperature of hot air, when a dry food is processed.

Adjusting the temperature of hot air by switching the exhaust damper 6 between the opening state and the closing state as in the case of the cooking apparatus A is easy and can be accurately made within a short period of time. On the other hand, adjusting the temperature of hot air by switching the exhaust damper 6 between the opening state and the closing state involves consumption of a large amount energy since the temperature is adjusted by mixing the heated hot air with external low-temperature air. Thus, when hot air is blown for a long period of time as in the case of processing a dry food, switching the exhaust damper 6 between the opening state and the closing state is not efficient to adjust the temperature.

In the cooking apparatus B, the temperature of hot air used for processing a dry food is lower than the temperature of hot air used for cooking (frying or baking) a food and the range of temperature adjustment is narrower than that in the case of cooking a food. Thus, the conditions of the temperature for processing a dry food are looser than the conditions of the temperature for cooking a food. In other words, when a dry food is processed, the temperature of hot air only has to fall within a certain range and does not have to be highly accurate.

In the cooking apparatus B, the temperature of hot air is adjusted by adjusting the output (temperature) of the heater 41 of the heating unit 4. The cooking apparatus B can adjust the temperature of hot air without switching the exhaust damper 6 between the opening and closing states to let external air in. In the adjustment of the output of the heater 41, it may take time to adjust the temperature of hot air. However, the amount of energy consumed by the heater 41 can be minimized.

When a dry food is processed by blowing hot air, the humidity of hot air is often more important than the temperature of hot air. Thus, in the cooking apparatus B, in order to regulate the humidity of hot air, the exhaust damper 6 is switched to the open state to exhaust the humid hot air (having a high humidity) inside the cooking apparatus B to the outside and to take in external dry air (having a lower humidity than the hot air).

When the cooking apparatus B cooks a dish by blowing hot air having a high temperature for a short period of time, the cooking apparatus B adjusts the temperature by heating hot air and taking external low-temperature air in in the same manner as in the case of the cooking apparatus A. Thus, in the following description, the case where the cooking apparatus B processes a dry food is described.

Now, dry foods processed by the cooking apparatus B according to the embodiment of the present disclosure will be described. As described above, the database of the memory 92 of the cooking apparatus B contains, in addition to the dishes described above, processing conditions for each dry food such as a processing temperature, a processing humidity, and the length of time for which the temperature or humidity is kept.

Now, processing conditions for a first processed product D1 (here, a dry fruit), which is an example of a processed product, will be described. Processing conditions for the first processed product D1 are “to increase the internal temperature t of the inner pan 2 to a third temperature T3 at a rate of increase in temperature within a certain range”, “to keep the internal temperature t of the inner pan 2 at the third temperature T3 and keep the humidity h of hot air at a first humidity H1 or lower for a predetermined period of time”, and “to reduce the internal temperature t of the inner pan 2”.

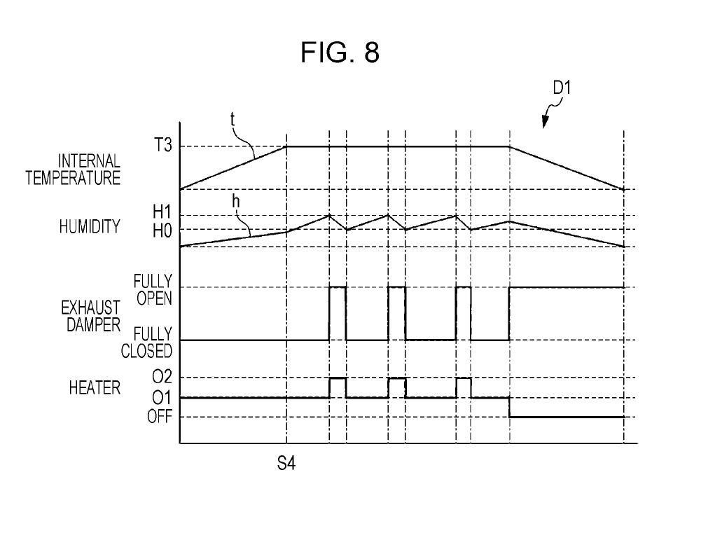

Now, the operation of the cooking apparatus B when processing the first processed product D1 will be described. FIG. 8 is a timing chart for when the cooking apparatus according to the embodiment processes a dry food. The operation up to the start of processing is the same as the operation performed when the cooking apparatus A performs cooking and is thus not described. When the controller 91 receives information that the processing is started, the controller 91 drives the heater 41 and the fan 42 to start blowing hot air from the air outlet 113. Concurrently with the processing start, the temperature detector 93 detects the internal temperature t of the inner pan 2 and (periodically) passes information of every detection to the controller 91.

The humidity detector 95 detects the humidity h of hot air and (periodically) passes information of every detection to the controller 91. The temperature detection of the temperature detector 93 and the humidity detection of the humidity detector 95 may be performed concurrently or separately. The controller 91 controls the opening and closing states of the exhaust damper 6 on the basis of information of the internal temperature t and information of the humidity h of hot air.

As illustrated in FIG. 8, in the cooking apparatus B, the internal temperature t of the inner pan 2 is lower than the third temperature T3 immediately after the processing start. One of the processing conditions for the first processed product D1 is “to increase the internal temperature t of the inner pan 2 to the third temperature T3 at a rate of increase in temperature within a certain range”. In other words, the condition is “to keep the output of the heater 41 uniform and bring the internal temperature t to the third temperature T3 by the time S4 after the processing start”. Thus, the controller 91 determines the output O1 of the heater 41 that satisfies the above-described condition and controls the heater 41 so that the heater 41 produces the output O1.

In this manner, hot air circulates inside the cooking apparatus B and the temperature of the hot air increases as a result of being heated by the heater 41 while circulating. Thus, the internal temperature t of the inner pan 2 that receives the hot air also increases. In FIG. 8, the temperature of the hot air reaches the third temperature T3 at the time S4 after the processing start. The controller 91 does not adjust the humidity while increasing the internal temperature t and controls the exhaust damper 6 so that the exhaust damper 6 is in the closed state.

Another one of the processing conditions for the first processed product D1 is “to keep the internal temperature t of the inner pan 2 at the third temperature T3 and keep the humidity h of hot air at the first humidity H1 or lower for a predetermined period of time”. Thus, the controller 91 switches the exhaust damper 6 between the open and closed states on the basis of information of the humidity from the humidity detector 95.

When hot air is circulated inside the cooking apparatus B, the heat of the hot air is absorbed by the object or exhausted to the outside by way of some components of the apparatus such as the outer pot 11 or the front board 8. As illustrated in FIG. 8, since the hot air circulating inside is heated by the heater 41, the temperature of the hot air blown out from the air outlet 113 is adjusted to be uniform or substantially uniform. On the other hand, as illustrated in FIG. 8, the humidity of the hot air increases by blowing hot air to the object. The controller 91 switches the exhaust damper 6 to the open state when the humidity h of the hot air exceeds the first humidity H1 (reaches the first humidity H1).

When the exhaust damper 6 is switched to the open state, hot air having a high humidity is exhausted to the outside and external air flows in, whereby the humidity h of hot air decreases. Although external air sometimes has a high relative humidity, in most of the cases, external air outside the cooking apparatus B has a lower humidity than hot air circulating inside when the external air is heated up to the temperature of the hot air. Thus, even in the case where external air has a high relative humidity, the humidity of the hot air can be reduced by letting the external air in and mixing the external air with the hot air.

When the exhaust damper 6 is switched to the open state to mix hot air with external air, the temperature of the hot air decreases as well as the humidity h of the hot air. When the temperature of the hot air decreases, the internal temperature t of the inner pan 2 may also decrease and fail to satisfy the processing conditions. Thus, the controller 91 controls the heater 41 so that the output of the heater 41 is increased (to the output O2) to regulate the temperature of hot air (see FIG. 8). Here, the output of the heater 41 is changed in such a manner that the internal temperature t of the inner pan 2 becomes the third temperature T3. Alternatively, the change in output of the heater 41 may be determined on the basis of the temperature of intake air or the flow rate of intake of air.

The controller 91 controls the exhaust damper 6 so that the exhaust damper 6 is in the closed state when the humidity h of hot air reaches a reference humidity h0, which is lower than the first humidity H1. When the exhaust damper 6 is switched to the closed state, the output of the heater 41 is concurrently returned to the original output O1. This control enables a reduction of the ratio of the control of the heater 42 at the high output O2. However, this is not the only possible control. The exhaust damper 6 may be switched to the open state until the humidity is lowered further.

When the humidity h of hot air is adjusted to the first humidity H1 or lower, the controller 91 keeps the exhaust damper 6 in the open state for a predetermined period of time. However, this is not the only possible control. For example, as in the case of the first embodiment, the humidity may be controlled so as to be uniform or substantially uniform by switching the exhaust damper 6 between the open state and the closed state in a predetermined operation cycle. Such a control prevents a large amount of external air having a low temperature from flowing in in a short period of time and the temperature of hot air from rapidly decreasing. Since the temperature of hot air changes gradually, the degree to which the output of the heater 41 is adjusted can be reduced, whereby energy consumption can be minimized.

Another one of the processing conditions for the first processed product D1 is “to reduce the internal temperature t of the inner pan 2”. Thus, the controller 91 controls the exhaust damper 6 so that the hot air inside the cooking apparatus A having a high temperature is immediately exhausted to the outside. The controller 91 controls the exhaust damper 6 so that the exhaust damper 6 is kept in the open state in order to effectively exhaust the hot air to the outside (see FIG. 8). At this time, the hot air is no longer required to be blown to the object, and thus the heater 41 is stopped. On the other hand, the fan 42 is kept rotating to facilitate exhaustion of hot air from the exhaust port 114.

Since the processing conditions for the first processed product D1 do not include the ratio of reduction of temperature, the controller 91 controls the exhaust damper 6 and the heater 41 in the above-described manner. However, this is not the only possible control. For example, when the ratio of reduction of temperature is limited to a certain range, the temperature may be controlled so as to be reduced without switching the exhaust damper 6 to the open state or by switching the exhaust damper 6 between the open and closed states in a certain cycle and stopping the heater 41 or reducing the output of the heater 41.

In this manner, the cooking apparatus B can control the opening and closing states of the exhaust damper 6 to adjust the humidity, whereby an object can be processed so as to be adjusted to an accurate degree of dryness.

The cooking apparatus described above can accurately adjust the temperature of high-temperature hot air for cooking an object by blowing the hot air for a short period of time. In addition, the cooking apparatus can accurately adjust the temperature and the humidity of low-temperature hot air (hot air having a temperature higher than external air but lower than hot air used for cooking) for processing an object.

This embodiment describes that water in an object evaporates as a result of hot air being blown to the object and the humidity of hot air increases. However, this is not the only possible case. For example, oil or fat may also evaporate by being heated and the oil or fat may be mixed in the hot air. Also in such a case, the evaporated oil or fat mixed in the hot air can be reduced by switching the exhaust damper 6 to the open state to exhaust part of the hot air, whereby the evaporated oil or fat is hindered from adhering to the object again. Consequently, the object can have a fine quality. This structure also enables a reduction of an intake of oil or fat.

In this embodiment, the output of the heater 41 is adjusted and the change of the internal temperature t of the inner pan 2 is regulated by switching the exhaust damper 6 between the open and closed states. However, this is not the only possible structure. For example, the output of the heating device 43 that heats the inner pan 2 from the external side may be adjusted while the output of the heater 41 is kept uniform. Alternatively, both the heater 41 and the heating device 43 may be controlled so that the internal temperature t of the inner pan 2 becomes uniform.

Although the humidity is not described in the cooking operation of the cooking apparatus A, the humidity of hot air decreases when the hot air is exhausted and external air is taken in to adjust the temperature. Thus, as in the case of the cooking apparatus B, the humidity of hot air can be regulated also in the cooking apparatus A. In the case where the cooking apparatus A performs cooking or the cooking apparatus B performs cooking in the same manner as in the cooking apparatus A, hot air having a low humidity is blown to an object, whereby an increase in humidity of the surface of the object is minimized and the cooked food can have a fine quality. When the temperature of hot air is to be increased, it takes time until the temperature reaches a predetermined temperature if the humidity is high, whereby the power consumption increases. When the humidity is adjusted by exhausting hot air in the cooking apparatus A in the above-described manner, the temperature of hot air can be efficiently increased in a short period of time.

The same goes for the oil or fat content. A cooked dish can have a high quality as a result of a reduction of evaporated oil or fat contained in the hot air. The reduction of evaporated oil or fat contained in the hot air enables a reduction of oil or fat contained in the cooked dish, whereby the intake of oil or fat can be reduced.

A cooking apparatus according to some embodiments described above includes an exhaust damper 6 that opens or closes the exhaust port 114. However, this is not the only possible structure. An exhaust damper 6 may be provided inside an exhaust duct 116 so as to open or close the exhaust duct 116. In addition, although a cooking apparatus that includes one exhaust port 114 is disclosed herein, this is not the only possible structure. A cooking apparatus may include multiple exhaust ports. In this case, multiple exhaust ducts 116 may be respectively provided to the multiple exhaust ports 114 and multiple exhaust dampers 6 may be respectively provided to the exhaust ports 114. Alternatively, some or all of the exhaust ports 114 may be connected to a common exhaust duct 116 and the joined portion of the exhaust duct 116 may be opened or closed by an exhaust damper 6. Various types of the exhaust port 114 or the exhaust damper 6 that are disposed so as to control discharge of hot air to the outside through the exhaust duct 116 can be used.

The exhaust damper 6 described in some embodiments is formed so as to be switchable between the fully open state and the fully closed state. However, this is not the only possible form of the exhaust damper 6. For example, the exhaust damper 6 may have a flow rate control function so as to be switched to various different states, between the fully open state and the fully closed state, which have different degrees of opening (different flow rates). In this case, the exhaust damper 6 is controlled so as to keep the degree of opening, which is the ratio of an open portion with respect to the fully open state, instead of repeatedly switching the exhaust damper 6 between the open state and the closed state, so that the similar effects can be obtained.

### Third Embodiment

Now, a cooking apparatus according to a third embodiment of the present disclosure will be described. As illustrated in FIG. 1, the air outlet 113, the exhaust port 114, and the intake port 115 are positioned at an upper front portion of the outer pot 11. This positioning can hinder an object, water, or other objects from entering the air outlet 113, the exhaust port 114, and the intake port 115 when the object is taken in or out or at the maintenance of the outer pot 11, whereby problems concerning the maintenance of the cooking apparatus can be minimized.

In the case where the apparatus has a structure in which hot air is blown from an upper opening of the inner pan 2, the inner pan 2 does not have a portion that allows hot air to pass through other than the upper opening. The hot air that has been blown to the inner pan 2 thus bounces off the bottom portion of the inner pan 2. Then, the hot air that has blown out from the air outlet 113 is divided into two parts by the peripheral wall 21, guided along the peripheral wall 21, and then flows upward. Since the exhaust port 114 and the intake port 115 are disposed on both sides of the air outlet 113, the hot air that has flowed along the peripheral wall 21 can effectively flows out of the outer pot 11 from the intake port 115 and (or) the exhaust port 114.

In this manner, hot air can be efficiently exhausted and circulated. Thus, the internal temperature t of the inner pan 2 can be adjusted with high accuracy as a result of exhaustion of the hot air. The humidity of the hot air can be similarly adjusted with high accuracy.

In the cooking apparatus illustrated in FIG. 1, the exhaust port 114 and the intake port 115 are symmetrically disposed on both sides of the air outlet 113. However, this is not the only possible positioning. In the cooking apparatus according to the embodiment of the present disclosure, the temperature and the humidity are adjusted by exhausting hot air through the exhaust port 114 and the exhaust duct 116. Thus, the exhaust port 114 may be formed on the path of hot air for efficient exhaustion of hot air and an accurate adjustment of the temperature and the humidity. In addition, the exhaust port 114 may have a large cross-sectional area to increase the flow rate of hot air.

When the exhaust damper 6 is in the closed state, only the intake port 115 serves as an opening that allows hot air to flow out of the outer pot 11. Thus, the intake port 115 does not necessarily have to be on the path while hot air is blown out from the air outlet 113. The intake port 115 may have such a cross-sectional area that the hot air can stably circulate between the outer pot 11 and the circulation flow path 40.

### Fourth Embodiment

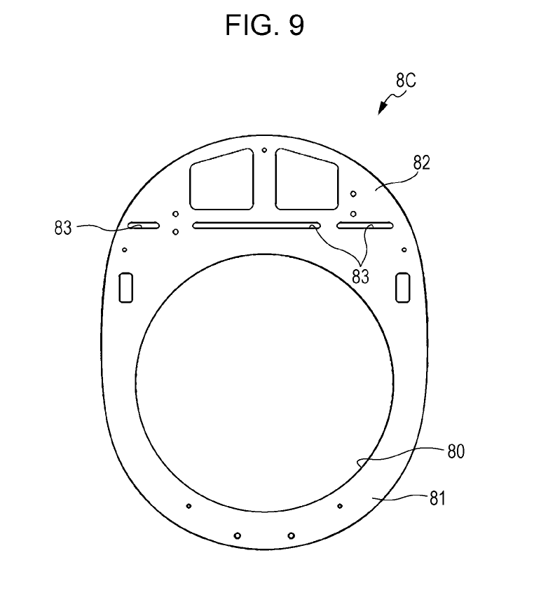

Referring to the drawings, a cooking apparatus according to a fourth embodiment of the present disclosure will be described. FIG. 9 is a plan view of a front board 8C included in the cooking apparatus according to the embodiment of the present disclosure. The front board 8C according to the embodiment can be installed in an apparatus having the same structure as the cooking apparatus A according to the first embodiment. Thus, components of the cooking apparatus are denoted by the same reference symbols as those of the cooking apparatus A.

As illustrated in FIG. 9, the front board 8C includes a cooking front-board portion 81 at which the outer pot 11 and the inner pan 2 are disposed, an operating front-board portion 82 disposed above the cooking front-board portion 81 and at which the operating unit 7 is disposed, an open window 80 formed in the cooking front-board portion 81 to allow an object to be taken in and out therethrough, and holes 83 formed between the cooking front-board portion 81 and the operating front-board portion 82.

The operating unit 7 is disposed at the operating front-board portion 82 of the front board 8. The cooking apparatus A is an apparatus that performs cooking by blowing hot air into the inner pan 2, and the temperature of the front board 8C is increased by the hot air. The temperature of the front board 8C is increased by the hot air mainly at a portion of the cooking front-board portion 81 that covers the front portions of the outer pot 11 and the inner pan 2 and the high temperature (heat) is transferred to the operating front-board portion 82. Multiple (here, three) holes 83 are formed between the cooking front-board portion 81 and the operating front-board portion 82 of the front board 8C and serve as thermal resistance. The holes 83 thus prevent the heat of the cooking front-board portion 81 from being transferred to the operating front-board portion 82 and the temperature at the operating front-board portion 82 from increasing excessively. The holes 83 may have a maximum size within a range in which the front board 8C has a tolerable strength.

The operating unit 7 includes components such as the display portion 71 and the input portion 72, which are susceptible to heat. In the front board 8C illustrated in FIG. 9, the holes 83 hinder the heat of the cooking front-board portion 81 from being transferred to the operating front-board portion 82, whereby an increase in temperature of the operating unit 7 due to the hot air is minimized. Consequently, problems such as malfunctions or breakdowns of electric components included in the operating unit 7 due to an increase in temperature can be minimized.

### Fifth Embodiment

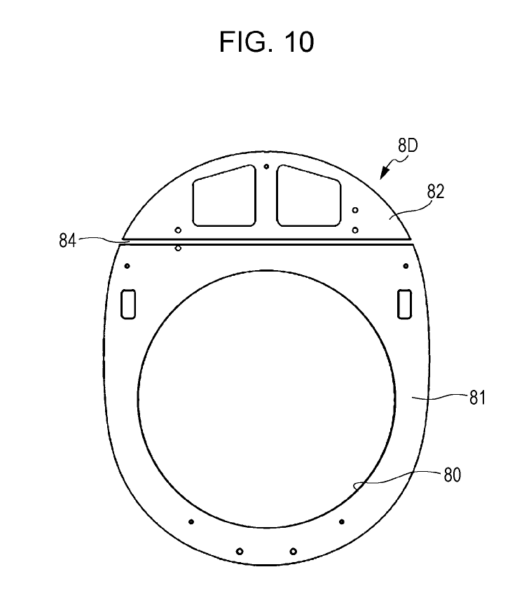

Referring now to the drawings, a cooking apparatus according to a fifth embodiment of the present disclosure will be described. FIG. 10 is a plan view of a front board 8D included in the cooking apparatus according to the embodiment of the present disclosure. The front board 8D according to the embodiment can be installed in an apparatus having the same structure as the cooking apparatus A according to the first embodiment. Thus, components of the cooking apparatus are denoted by the same reference symbols as those of the cooking apparatus A.

As illustrated in FIG. 10, the front board 8D includes a cooking front-board portion 81 at which the outer pot 11 and the inner pan 2 are disposed, an operating front-board portion 82 disposed above the cooking front-board portion 81 and at which the operating unit 7 is disposed, and an open window 80 formed in the cooking front-board portion 81 to allow an object to be taken in and out therethrough. In the front board 8D, the cooking front-board portion 81 and the operating front-board portion 82 are separately formed. When the cooking front-board portion 81 and the operating front-board portion 82 are attached to the housing 11, a gap 84 is formed between the cooking front-board portion 81 and the operating front-board portion 82.

The presence of the gap 84 hinders the heat from being transferred between the cooking front-board portion 81 and the operating front-board portion 82, whereby problems such as malfunctions or breakdowns of the operating unit 7 can be minimized.

### Sixth Embodiment

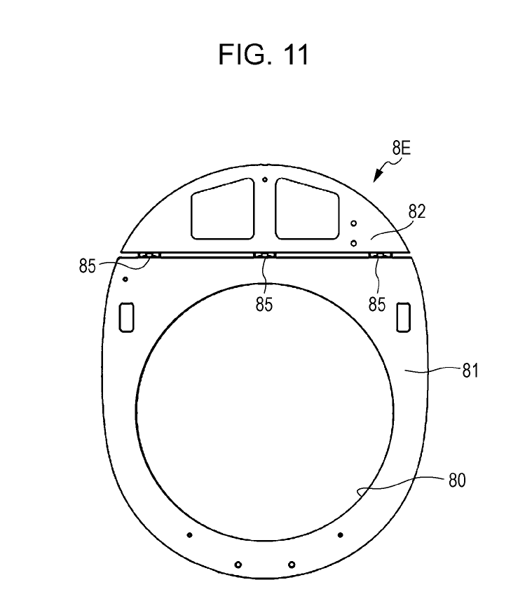

Referring to the drawings, a cooking apparatus according to a sixth embodiment of the present disclosure will be described now. FIG. 11 is a plan view of a front board 8E included in the cooking apparatus according to the embodiment of the present disclosure. The front board 8D according to the embodiment can be installed in an apparatus having the same structure as the cooking apparatus A according to the first embodiment. Thus, components of the cooking apparatus are denoted by the same reference symbols as those of the cooking apparatus A.

As illustrated in FIG. 11, the front board 8E includes a cooking front-board portion 81 at which the outer pot 11 and the inner pan 2 are disposed, an operating front-board portion 82 disposed above the cooking front-board portion 81 and at which the operating unit 7 is disposed, and an open window 80 formed in the cooking front-board portion 81 to allow an object to be taken in and out therethrough. In the front board 8E, the cooking front-board portion 81 and the operating front-board portion 82 are separately formed. The operating front-board portion 82 has projections 85. The cooking front-board portion 81 and the projections 85 are fixed to each other with screws.

In this structure, the cooking front-board portion 81 and the operating front-board portion 82 are connected with each other at the projections 85 having a small width. Thus, the thermal resistance between the cooking front-board portion 81 and the operating front-board portion 82 is high. Consequently, the heat transfer from the cooking front-board portion 81 to the operating front-board portion 82 can be minimized, whereby problems such as malfunctions or breakdowns that would occur if the operating unit 7 were heated can be minimized. Here, screws are not the only possible devices for fixing the projections 85 and the cooking front-board portion 81 together. Alternatively, various other devices with which the projections 85 and the cooking front-board portion 81 can be firmly fixed together may be used such as by welding or rivet connection. Although it is described that the operating front-board portion 82 has the projections 85, this is not the only possible structure. The cooking front-board portion 81 may include projections or both the cooking front-board portion 81 and the operating front-board portion 82 may include projections.

Although embodiments of the present disclosure have been described thus far, the present disclosure is not limited to these embodiments. Embodiments of the present disclosure can be modified in various manners within the scope of the disclosure.

A cooking apparatus according to an embodiment of the present disclosure is a cooking apparatus that performs a heating operation by circulating and blowing hot air to an object, the apparatus including a bottomed-box-shaped container that contains the object, a discharging path through which at least part of the hot air is discharged to the outside, an exhaust adjustment unit that adjusts the flow rate of discharge of hot air through the discharging path, and a controlling unit that controls the exhaust adjustment unit, wherein the exhaust adjustment unit is disposed at a portion of the discharging path, and the controlling unit controls the exhaust adjustment unit in such a manner that the flow rate of discharge of hot air during the heating operation falls within a predetermined condition.

By controlling the exhaust adjustment unit, part of the hot air is exhausted to the outside and the conditions (the temperature, the humidity, or the amount of evaporated oil or fat) during the heating operation are brought to the levels that satisfy predetermined conditions, whereby the conditions during the heating operation can be regulated with a simple control. Thus, an object cooked with such a simple control can have a fine quality. In addition, this positioning of the exhaust adjustment unit enables an efficient discharge of the hot air to the outside.

A cooking apparatus according to some embodiments of the present disclosure includes an air blowing unit on the circulation path. The cooking apparatus may include an air vent on the circulation path upstream from the air blowing unit, the air vent allowing air to be discharged therethrough when the exhaust adjustment unit regulates the flow rate of the hot air.

The presence of the air vent enables discharge of air through the air vent while the exhaust adjustment unit regulates the rate of discharge (mainly when restricting discharge). Thus, an increase in internal pressure due to an increase in temperature can be minimized.

In a cooking apparatus according to some embodiments of the present disclosure, the exhaust adjustment unit may fully open or close the discharging path and the controlling unit may adjust the rate of discharge by repeatedly fully opening or closing the discharging path with a change of the ratio between the length of time of the fully open state of the exhaust adjustment unit and the length of time of the fully closed state of the exhaust adjustment unit.

In this manner, the conditions during the heating operation can be set so as to satisfy predetermined conditions by only repeatedly adjusting the ratio between the length of time of the fully open state of the exhaust adjustment unit and the length of time of the fully closed state of the exhaust adjustment unit. Thus, the control is easy and the conditions can be adjusted with high accuracy in a short period of time. Moreover, since the time taken to adjust the state is short, the energy consumption can be kept to a minimum.

A cooking apparatus according to some embodiments of the present disclosure may include a temperature detecting unit that detects the internal temperature of the container. The controlling unit may acquire information of the internal temperature from the temperature detecting unit and control the exhaust adjustment unit in such a manner that the flow rate of hot air is adjusted so that the internal temperature satisfies the predetermined conditions.

In this structure, the temperature of hot air is adjusted by adjusting the flow rate of hot air discharged to the outside so that the internal temperature of the container is adjusted so as to satisfy predetermined conditions. Thus, the control is easy and the conditions can be adjusted with high accuracy in a short period of time. Moreover, since the flow rate of discharge of hot air is adjusted on the basis of the internal temperature, the flow rate of discharge of hot air can be regulated, whereby the energy consumption can be kept to a minimum.

A cooking apparatus according to some embodiments of the present disclosure may include a humidity detecting unit that detects the humidity of hot air. The controlling unit may acquire information of the humidity of hot air from the humidity detecting unit and control the exhaust adjustment unit in such a manner that the flow rate of hot air is adjusted so that the humidity of hot air satisfies the predetermined conditions.

In this structure, the humidity of hot air is adjusted by adjusting the flow rate of hot air discharged to the outside so that the internal humidity of the container is adjusted so as to satisfy predetermined conditions. Thus, the control is easy and the conditions can be adjusted with high accuracy in a short period of time. Moreover, since the time taken to adjust the state is short, the energy consumption can be kept to a minimum. In addition, since the rate of discharge is adjusted in accordance with a change in humidity, the flow rate of discharge of hot air is regulated, whereby the energy consumption can be kept to a minimum.

A cooking apparatus according to some embodiments of the present disclosure may include a recording unit on which the predetermined conditions are recorded. The controlling unit may read the predetermined conditions from the recording unit when performing the heating operation.

The cooking apparatus having such a structure can perform various different heating operations. Thus, such a structure can expand the applicable range of the cooking apparatus.

A cooking apparatus according to some embodiments of the present disclosure may heat an object by blowing hot air to the object while circulating the hot air, the cooking apparatus including a bottomed-box-shaped container having an opening, in which the object is contained, at an upper portion, and an exhaust port through which at least part of the hot air inside the container is exhausted to the outside, the exhaust port being disposed adjacent to the opening of the container at the upper portion.

This structure can hinder an object, a component, water, or other objects from entering the exhaust port in a heating operation, daily cleaning, a maintenance, or other occasions.

The cooking apparatus having this structure may have an air outlet, from which hot air is blown, and an intake port, through which hot air is circulated, at an upper portion of the container.

In the cooking apparatus having this structure, the exhaust port may be disposed so as to overlap the flow path of the hot air.

A cooking apparatus according to some embodiments of the present disclosure may heat an object by blowing hot air to the object. The cooking apparatus may include a housing having an opening in a front surface, a bottomed-box-shaped container that is disposed inside the opening and that contains the object, a front board that is attached to the opening and that has a hole through which the object is inserted into the container, and a processor including an electric component. The front board may include a first portion to which the container is attached and a second portion to which the processor is attached. A hole may be formed between the first portion and the second portion.

The hole in this structure increases a thermal resistance between the first portion and the second portion. Thus, the heat of the first portion that occurs due to hot air being blown to the first portion is negligibly transferred to the second portion. An increase in temperature of the second portion is thus minimized, whereby malfunctions or breakdowns of electric components of the processor can be minimized.

The front board may have separate first and second portions and the first and second portions may be attached to the housing without touching each other. In this configuration, a gap between the first portion and the second portion hinders the heat from being transferred to each other and an increase in temperature of the second portion is thus minimized, whereby malfunctions or breakdowns of electric components of the processor can be minimized.

The separate first and second portions may be connected to each other using connection protrusions formed at at least one of the first portion and the second portion. Here, the first portion and the second portion may be fixed to each other with, for example, a screw, which is not the only possible device. Various different devices that can firmly fix the first portion and the second portion together may be used such as welding or rivet connection.

Embodiments of the present disclosure are applicable to cooking of dishes such as fritters, fried pork cutlets, croquettes, fried shrimps, deep-fried foods, or other dishes deep-fried in batter.

It should be understood by those skilled in the art that various modifications, combinations, sub-combinations and alterations may occur depending on design requirements and other factors insofar as they are within the scope of the appended claims or the equivalents thereof.

What is claimed is:

1. A cooking apparatus that performs a heating operation by blowing hot air on an object, the apparatus comprising:
a circulation path through which the hot air is circulated;
a bottomed-box-shaped container that contains the object;
a discharging path through which at least part of the hot air is discharged to the outside;
an exhaust adjustment unit that adjusts a flow rate of discharge of the hot air through the discharging path; and
a controlling unit that controls the exhaust adjustment unit,
wherein the exhaust adjustment unit is disposed at a portion of the discharging path, and
wherein the controlling unit controls the exhaust adjustment unit in such a manner that the flow rate of discharge of the hot air during the heating operation falls within a predetermined condition.

2. The cooking apparatus according to claim 1, further comprising:
an air blowing unit disposed at the circulation path, and
an air vent disposed at the circulation path upstream from the air blowing unit, the air vent allowing discharge of the hot air when the exhaust adjustment unit regulates the flow rate of discharge of the hot air.

3. The cooking apparatus according to claim 1,
wherein the exhaust adjustment unit fully opens or fully closes the discharging path, and
the controlling unit adjusts a flow rate of the hot air with a ratio between a length of time for which the exhaust adjustment unit fully opens the discharging path and a length of time for which the exhaust adjustment unit fully closes the discharging path.

4. The cooking apparatus according to claim 1, further comprising:
a temperature detecting unit that detects an internal temperature of the container,
wherein the controlling unit acquires information of the internal temperature from the temperature detecting unit and controls the exhaust adjustment unit in such a manner that the flow rate of discharge of the hot air is adjusted so that the internal temperature satisfies the predetermined condition.

5. The cooking apparatus according to claim 1, further comprising:
a humidity detecting unit that detects a humidity of the hot air,
wherein the controlling unit acquires information of the humidity of the hot air from the humidity detecting unit and controls the exhaust adjustment unit in such a manner that the flow rate of discharge of the hot air is adjusted so that the humidity of the hot air satisfies the predetermined condition.
